(19) United States
(12) Patent Application Publication
(10) Pub. No.: US 2018/0325154 A1
(43) Pub. Date: Nov. 15, 2018

(54) METHOD OF PROCESSING FOOD AND A PRODUCT THEREOF

(71) Applicant: St. James' Settlement, Wanchai (HK)

(72) Inventors: Yee Man, Cora WONG, Wanchai (HK); Ping Chung, Ronald, TANG, Wanchai (HK)

(21) Appl. No.: 15/921,718

(22) Filed: Mar. 15, 2018

(30) Foreign Application Priority Data
May 9, 2017 (HK) 17104652.2

(51) Int. Cl. A23L 29/244; A23L 29/212; A23L 33/00; A23L 27/10; A23P 30/10; A23L 13/60; A23L 13/40; A23L 19/00; A23L 19/10

(52) U.S. Cl. CPC A23L 29/244; A23L 29/212; A23L 33/40; A23L 27/10; A23P 30/10; A23V 2002/00; A23L 13/428; A23L 13/426; A23L 19/09; A23L 19/10; A23L 13/67

(57) ABSTRACT

A method of processing food suitable for dysphagia patient comprising the steps of processing a food material into food puree, introducing first thickening agent and second thickening agent, mixing the food puree, the first and second thickening agents to form a food paste, inserting the food paste into a container with a preferred shape, and allowing the food paste to set; and a product manufactured by said method.

The present invention relates to a method of processing food, for example particularly, but not exclusively, food for dysphagic patients.

### BACKGROUND OF THE INVENTION

Dysphagia is a medical term for the symptom of difficulty in swallowing. When dysphagia is disregarded, patients are at high risk of pulmonary aspiration, dehydration, malnutrition and renal failure. Malnutrition may lead to higher morbidity and mortality, resulting in poor quality of life.

Conventional processed food in a texture modified diet such as food puree is available for Dysphagic patients. Pureed food is a complete vandalization of all texture in food rendering it easy to ingest in the sacrifice of the enjoyment and pleasure of eating.

Processed food is prepared for relatively long-term storage and requires reheating to serve. Due to the lost in food texture, conventional puree runs like sauce. Rather than eating, the ingestion is more appropriately described as drinking. For elderly who have experienced the normal way of consuming food may show hesitation in the acceptance of pureed food, putting their health at risk.

Reheating a texture-less food would post little problem but if the food is shaped for visual enhancement, reheating may compromise such effort.

The invention seeks to eliminate or at least to mitigate such shortcomings by providing an improved method of processing food.

### SUMMARY OF THE INVENTION

According to the invention, there is provided a method of processing food suitable for dysphagia patient comprising the steps of processing a food material into food puree, introducing first thickening agent and second thickening agent, mixing the food puree, the first and second thickening agents to form a food paste, inserting the food paste into a container with a preferred shape, and allowing the food paste to set; Preferably, the first thickening agent comprises Konjac; More preferably, the second thickening agent comprises modified maize starch; It is preferable that the method further comprising the step of adding yeast extract to the food material before processing the food material into food puree; It is preferable that the method further comprising the step of adding supplements to the food puree before mixing; It is preferable that the method further comprising the step of cooking the food material before processing the food material into food puree; Preferably, the first thickening agent is about 0.5%-1.2% of the weight of the food material; More preferably, the second thickening agent is about 5%-9% of the weight of the food material; It is preferable that the method further comprising the step of blast-chilling the food paste in the container; Advantageously, the blast-chilling is conducted at a temperature of at least −18° C. or below; It is preferable that the method further comprising the step of reheating the food paste at 100° C. for at least 25 mins to allow core of the paste to reach a temperature of 75° C. or above.

According to a second aspect of the invention there is provided a product of processed food manufactured by the aforementioned method, having a predefined shape comprising a mixture of food material, first and second thickening agents; Advantageously, the first thickening agent is Konjac and the second thickening agent comprises modified maize starch of preferred amount; More advantageously, the preferred amount of the first thickening agent is about 0.5%-1.2% of the weight of the food material; Yet more advantageously, the preferred amount of the second thickening agent is about 5%-9% of the weight of the food material; It is preferable that the method further comprising yeast extract; Preferably, the product is in the form of a platelet with specific shape defined by a food container in which the product is contained and sealed.

### BRIEF DESCRIPTION OF DRAWINGS

The invention will now be more particularly described, by way of example only, with reference to the accompanying drawings, in which:

FIG. 1 is a block diagram showing a method of processing food in accordance with the invention;

FIG. 2 is a table showing results of a spreadability test;

FIG. 3 is a table showing consistency and texture of various types of food product processed by the method as detailed in FIG. 1; and

FIG. 4 is a photo showing the external appearance of the various types of food product mentioned in FIG. 3.

### DETAILED DESCRIPTION OF PREFERRED EMBODIMENT

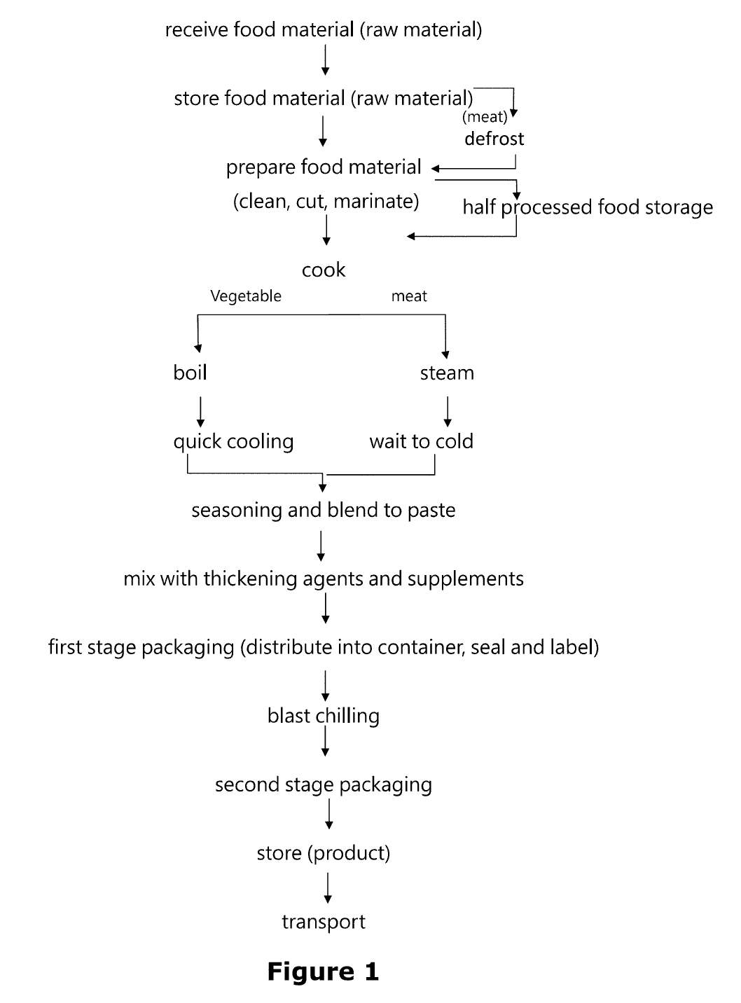

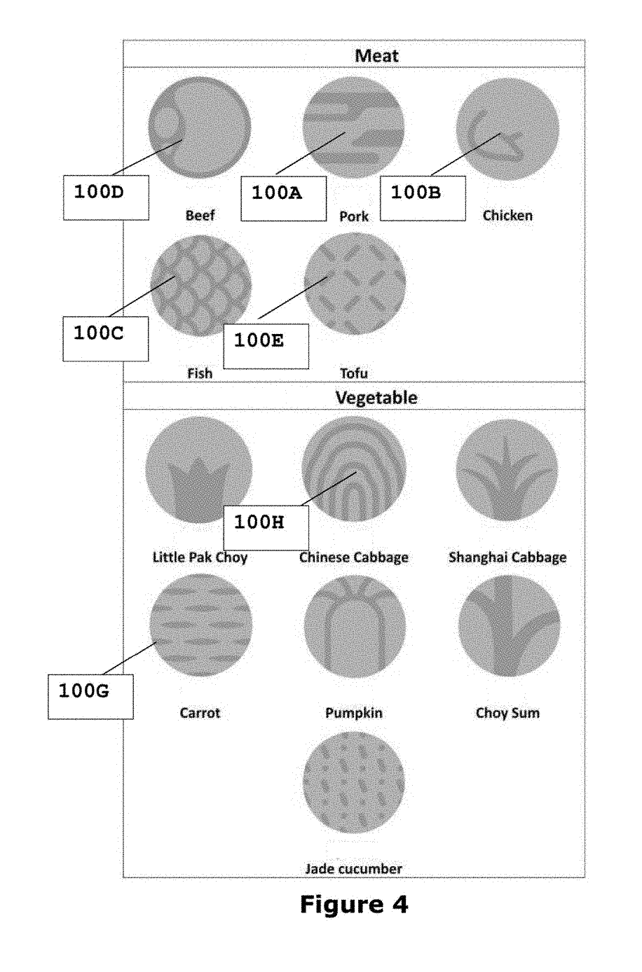

Referring to FIGS. 1 to 4, food product in the form of platelet 100 is produced by following the general steps as illustrated in FIG. 1. Each of the platelet 100 as shown in FIG. 4 contains a dish of required nutrient such as a protein dish, a vegetable dish to go with carbohydrates such as puree rice or thick congee for achieving a well-balanced meal.

The platelets 100 form well-presented texture-modified diet to dysphagic patients. Each platelet 100 contains a formulated food being processed to produce a required consistency, appearance and nutrient content that meet the needs of dysphagic individuals.

It requires an appropriate amount of food ingredients, protein and thickener to achieve the required nutrient content and texture to achieve a preferred size and shape for proper packing and storage that ensures the safety of the products.

High quality meat and vegetables are first seasoned and cooked. These ingredients are blended to the desired consistency and immediately distributed into plastic molds. Sealed plastic molds then go through blast-chilling process until they are completely frozen and ready for consumption.

Depending on the type of food, each protein dish provides approximately 100 to 130 kilocalories with at least 14 grams protein, about 2 to 9 grams fat, and about 150 to 240 milligrams Sodium. Each vegetable dish provides about 40 to 50 kilocalories with 1 grams fat, about 170 to 270 milligrams Sodium, and at least 4 grams fibre, of which 1.5 grams are soluable fibre.

The platelets 100 can be stored up to 1 year in fridge at temperature −18° C. or below but are best for consumption within 180 days from production. Each of them is capable of tolerating 100° C. steaming for 25 minutes yet maintaining its shape without collapsing or undergo textural alteration. To be safe for consumption, the platelet 100 has to be heated at 100° C. for its core to attain a temperature of at least 75° C. after the platelet 100 is removed from steam (for how long has the temp need to be maintained?).

The platelets 100 are served in sets consisting of at least one protein dish and one vegetable dish and with a sauce as taste enhancer and as a top up to reach certain energy requirements.

To measure the texture properties of the platelet 100, a double cycle compression test is used to compare the platelets 100 from unprocessed food.

Eight samples of platelets 100 each containing a different type of food are used. The types of food include Pork, Chicken, Fish fillet, Brazilian beef, Tofu, Pak choi, Carrot and Napa cabbage.

Five samples of unprocessed food are used for comparison, including Fish belly, Wrap tofu, Board tofu, Beef ball, Winter melon. 3 centimeters thickness of each of these food materials in an unprocessed condition is used.

The results are calculated with the following formulae:

Hardness=Peak Positive Force (cycle 1)(=+ve Peak force of peak #1) A)

Cohesiveness=+ve area 2/+ve area 1 B)

Gumminess=Hardness×Cohesiveness=A×B C)

| RESULTS | Hardness (N) | Cohesiveness* | Gumminess (N) |
|---|---|---|---|
| Pork 100A | 0.2841 | 0.6405 | 0.6427 |
| Chicken 100B | 0.2052 | 0.598 | 0.1227 |
| Fish fillet | 0.2093 | 0.491 | 0.1028 |
| 100C | | | |
| Brazilian beef | 0.2689 | 0.4808 | 0.1293 |
| 100D | | | |
| Tofu 100E | 0.8433 | 0.4744 | 0.4 |
| | hardest | | |
| Pak choi 100F | 0.3977 | 0.4013 | 0.1596 |
| Carrot 100G | 0.1595 | 0.5351 | 0.0854 |
| | | | least gummy |
| Napa cabbage | 0.1302 | 0.6772 most | 0.0882 |
| 100H | | cohesive | |
| Fish belly | 1.4592 | 0.4889 | 0.7134 |
| Wrap tofu | 0.7898 | 0.2870 | 0.2267 |
| Board tofu | 0.8905 | 0.5864 | 0.5222 |
| Beef ball | 1.9361 | 0.8244 | 1.5961 |
| Winter melon | 1.1797 | 0.2087 | 0.2462 |

(N) = Newton
*= No unit

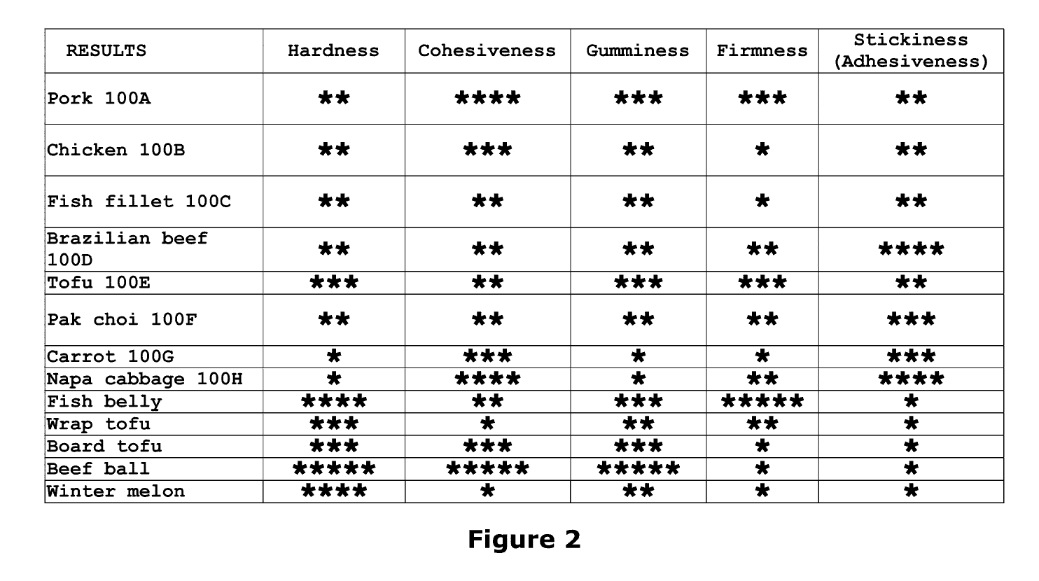

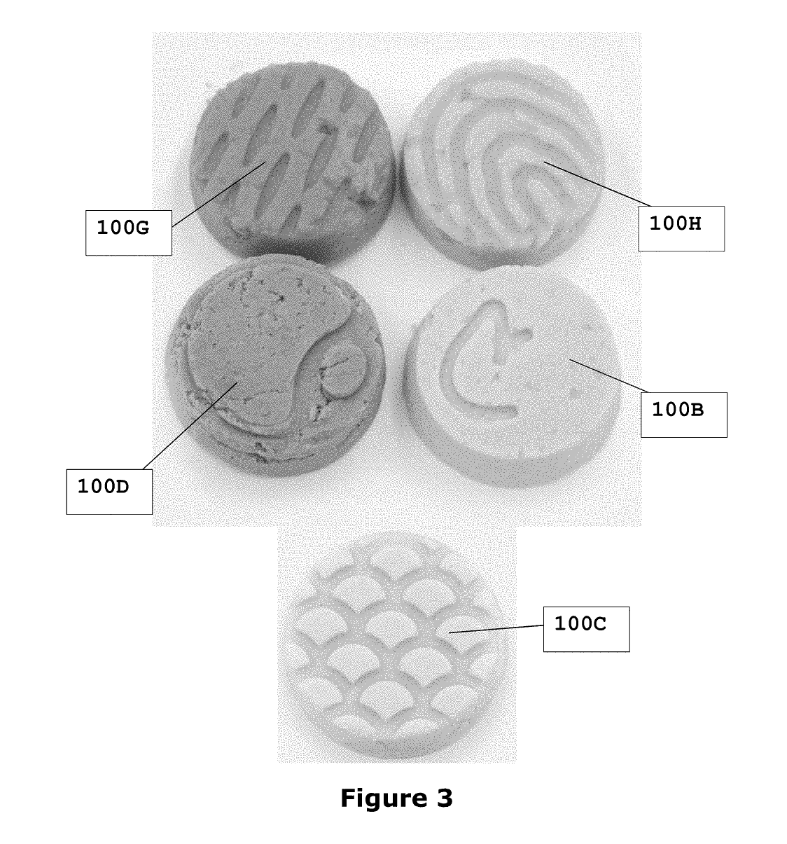

A spreadability test has been conducted with the results shown in FIGS. 2 and 3. The following definitions apply: Hardness is the force required to compress a food between the molars. It is defined as force necessary to attain a given deformation. The greater the value the greater the hardness.

| | | Stickiness (Ns) |
|---|---|---|
| RESULTS | Firmness (N) | (Adhesiveness) |
| Pork 100A | 117.52 | −15.54 |
| Chicken 100B | 78.37 | −12.76 |
| Fish fillet 100C | 75.46 | −17.22 |
| Brazilian beef 100D | 99.49 | −36.49 |
| | | most sticky |
| Tofu 100E | 133.56 | −10.27 |
| | firmnest | |
| Pak choi 100F | 96.64 | −33.5 |
| Carrot 100G | 64.3 | −27.31 |
| Napa cabbage 100H | 83.96 | −36.49 |
| | | most sticky |
| Fish belly | 388.39 | −7.76 |
| Wrap tofu | 101.06 | −1.86 |
| Board tofu | 80.36 | −1.45 |
| Beef ball | 74.35 | −1.95 |
| Winter melon | 55.59 | −5.90 |

(N) = Newton
(Nm) = Newton second

Cohesiveness is the strength of internal bonds making up the body of the product. The greater the value the greater the cohesiveness.

Gumminess is the energy required to disintegrate a semi-solid food product to a state ready for swallowing. It is more relevant to food with low hardness levels such as fish belly and tofu with firmness below 400N and hardness below 1.5 N. The smaller the value the smaller the gumminess.

Firmness is the force to withstand compression to cause deformation of food. The greater the value the greater the firmness.

Adhesiveness is the work necessary to overcome the attractive forces between the surface of food and the surface of other materials with which the food comes into contact (e.g. tongue, teeth, palate). It is the force required to pull food away from a surface multiplied by the distance that the food away from a surface. The greater the absolute value the greater the adhesiveness.

As shown in FIG. 3, each of the protein platelets 100 which contain pork 100A, chicken 100B, fish fillet 100C and Brazilian beef 100D respectively are generally 4-5 times softer than fish belly. Each of the vegetable platelets 100 which contain napa cabbage 100H, pak choy 100G and carrot 100F respectively are 3-4 times softer than winter melon. It is clear from the results that the content of the platelets 100 is easier for chewing, hence more suitable for dysphagia patients.

Based on the results, it is observed that the platelets 100 of all types have higher cohesiveness than unprocessed food such as tofu and winter melon such that they are less likely to crumble into smaller pieces in mouth thereby reducing the risk of choking.

The gumminess of the platelets 100 is comparable to unprocessed fish belly, tofu and winter melon, which indicates that the food can provide similar texture of unprocessed food.

The firmness of the platelets 100 is comparable to wrap tofu, board tofu, beef ball and winter melon and actually slightly higher, which indicates that the food can maintain its shape when serve.

The stickiness of the platelets 100 is unavoidably higher than unprocessed food to the addition of thickening agents, but is considered acceptable based on findings of customer satisfaction survey.

Referring to FIGS. 3 and 4, each type of food platelet 100 has its own marking but share a same general shape. The indication is most important to remain after heating at 100° C. by way of steaming for 25 minutes with a core temperature of at 75° C. such that the servant and the consumer are able to tell one platelet 100 from the other and have some knowledge of the food to be consumed. This is significantly different from conventional pureed food where all ingredients are mixed and pureed into poorly textured paste.

Each protein platelet 100 contains the raw food material e.g. fish of a desired amount, seasoning, flavor enhancer, protein supplement and thickener. These ingredients are well blended, sterilized and blast-frozen. More specifically, the flavor enhance involve using of a yeast extract which is a form of processed yeast product that is useful as food additives and flavouring. The thickener includes Konjac and modified maize starch in specific proportion resulting in a platelet 100 that is of the required homogeneity and texture, moldable yet being able to withstand heating at 100° C. without a change of the molded shape.

Experiments have been performed as comparative tests to demonstrate the importance of use of the mentioned types of thickening agents in specific proportion.

Case 1

When only modified maize starch is used, the platelet 100 being heated at 100° C. collapses in less than 20 mins. It is not possible to keep the desired shape of the platelet 100 while heating at 100° C. for 25 mins to allow the core of the platelet 100 to reach 75° C.

Case 2,

When only Konjac is used, a layer of relatively firm material is deposited on the outer of the platelet 100 and forms an outer surface of the platelet 100. The firmness and stickiness of this layer is greater than that of the desired platelet 100 rendering the platelet 100 unsafe for swallowing by a dsyphagia patient.

Case 3

When the amount of modified maize starch is about 10% by weight of the weight of the food material, the platelet 100 will still collapse after steaming, increase in the % by weight will not prevent collapsing but only dilute the nutrients in platelet 100. If larger than 10% of modified maize starch is added, the same problem as in Case 2 arises rendering the platelet 100 unsafe for swallowing by a dsyphagia patient.

Case 4

The preferred amount of Konjac and modified maize starch varies slightly depending on the food material used. The preferred amounts are as detailed below. In general the amount by weight of Konjac is about 0.5%-1.2% of the weight of the food material; the amount by weight of modified maize starch is about 5%-9% of the weight of the food material. When the amount of Konjac and modified maize starch are within the preferred range, the platelet 100 is able to maintain the preferred shape and texture when heated at 100° C. for 25 mins.

16 fish platelet 100C ingredients:
1.2 kg of fish
4 g of yeast extract

### 12 g of Konjac

108 g of modified maize starch
15 beef platelet 100D ingredients:
1.2 kg of beef
3 g of yeast extract

### 8 g of Konjac

62 g of modified maize starch
15 chicken platelet 100B ingredients:
1.2 kg of chicken
3 g of yeast extract

### 8 g of Konjac

62 g of modified maize starch
15 pork platelet 100A ingredients:
1.2 kg of pork
3 g of yeast extract

### 14 g of Konjac

70 g of modified maize starch
17 tofu platelet 100E ingredients:

### 1.2 kg of Tofu

4 g of yeast extract

### 8 g of Konjac

101 g of modified maize starch
15 Pak Choi platelet 100F ingredients:

### 1.6 kg of Pak Choi

2 g of yeast extract

### 16 g of Konjac

80 g of modified maize starch
15 Carrot platelet 100G ingredients:
1.4 g of carrot
2 g of yeast extract

### 9 g of Konjac

70 g of modified maize starch
15 Napa cabbage platelet 100H ingredients:

### 1.6 kg of Pak Choi

2 g of yeast extract

### 16 g of Konjac

85 g of modified maize starch

Referring to FIG. 1 in which the method of manufacturing the platelet 100 is summarized. The food material is collected and stored at an approved facility. Meat and vegetable are processed differently. Meat is defrosted, cleaned, cut and marinated before steaming. The cooked food is allowed to cool off. Vegetable is cleaned, cut and cooked. The cooked vegetable undergoes quick cooling and drying. The cold cooked meat or vegetable is seasoned and pureed. The thickening agents of the preferred proportions along with nutrient supplements are added and mixed well. The processed food is distributed into respective molds to form platelets 100, sealed, labeled and then blast-chilled. The chilled platelets 100 are packaged and stored for distribution.

In more detail, the meat when first received is maintained at or below −10° C. with the package intact. The vegetable when first received are inspected. All food materials are date checked.

The received food materials are stored according to a first come first serve basis.

Meat is completely defrosted at or below 4° C. Any resulting liquid is drained. Marinated meat are stored at 0-4° C. and cooked within 24 hours.

Meat is marinated/seasoned with homemade recipes in which the sodium level is controlled according to the types of meat, i.e. fish, chicken, pork, beef and tofu with the use of yeast extract in replacing MSG and other seasonings. Generally, the food material are cooked at or above 100° C. Core temperature of the food material has to be maintained at 75° C. for 15 seconds. Meat are defrosted for 30 minutes and steamed to 100° C. Fish, prawns/shrimps and tofu are steamed for about 10 minutes while other meats are steamed for 15 minutes. Any liquid of cooked meat are drained. The meat are cut into small pieces and cooled down with blast chiller. The cooked and cooled meat is blended into paste using high speed blender for about 4 to 5 minutes to a smooth consistency. The paste will then be mixed with Protein powder (99% whey protein) and thickening agents (Konjac and modified maize starch) using Hobart mixing machine with progressive increase in spinning speed. The mixture will then be injected into food grade containers in specified portion (100-105 g) to ensure the required nutrient content for packaging, labelling and then packed by the top-sealing machine. Final products will be blast-frozen in around 1 hour using blast-chillers and stored in freezer at around −18° C. The formula is specially designed that the products can be consumed easily after thawing and reheating in required texture.

Vegetables are stored at about 8° C. and meat are stored at or below −18° C. Vegetables are processed before meat to avoid contamination. Vegetables are cut into small pieces for even heating, washed and sterilized, for two minutes. All the vegetables will be sterilized and rinsed using Ozone water. And the formula will be adjusted according to the types of vegetables. Vegetable with green leaves are only half cooked while gourds are 80% cooked before blending. Cooked vegetables are cooled off using ozone water and dehydrated by compression. The cooked, cool and dry vegetable is blended into paste for about 4 to 5 minutes to a smooth consistency. The paste is then mixed with fiber powder (Partially Hydrolyzed Guar Gum) and thickening agents. The mixture is then injected into food grade containers in specific portions (100-105 g). The cooked, cooled paste are then labelled and packed by the top-sealing machine. Final products will be blast-frozen in around 1 hour using blast-chillers and stored in freezer at around −18° C.

Blast-chilling has to be completed within three hours from the food being injected into the food grade container.

All platelets 100 are labeled and dated. The platelets 100 are to be stored at or below −18° C. and maintained at below −12° C. during transportation.

The invention has been given by way of example only, and various other modifications of and/or alterations to the described embodiments may be made by persons skilled in the art without departing from the scope of the invention as specified in the appended claims.

1. A method of processing food suitable for dysphagia patient comprising the steps of:
processing a food material into food puree,
introducing first thickening agent and second thickening agent,
mixing the food puree, the first and second thickening agents to form a food paste,
inserting the food paste into a container with a preferred shape, and
allowing the food paste to set.

2. The method as claimed in claim 1, wherein the first thickening agent comprises Konjac.

3. The method as claimed in claim 1, wherein the second thickening agent comprises modified maize starch.

4. The method as claimed in claim 1 further comprising the step of adding yeast extract to the food material before processing the food material into food puree.

5. The method as claimed in claim 1 further comprising the step of adding supplements to the food puree before mixing.

6. The method as claimed in claim 1 further comprising the step of cooking the food material before processing the food material into food puree.

7. The method as claimed in claim 1, wherein the first thickening agent is about 0.5%4.2% of the weight of the food material.

8. The method as claimed in claim 1, wherein the second thickening agent is about 5%-9% of the weight of the food material.

9. The method as claimed in claim 1 further comprising the step of blast-chilling the food paste in the container.

10. The method as claimed in claim 9, wherein the blast-chilling is conducted at a temperature of at least −18° C. or below.

11. The method as claimed in claim 1 further comprising the step of reheating the food paste at 100° C. for at least 25 mins to allow core of the paste to reach a temperature of 75° C. or above.

12. A product of processed food manufactured by the method as claimed in claim 1, having a predefined shape comprising a mixture of food material, first and second thickening agents.

13. The product as claimed in claim 12, wherein the first thickening agent is Konjac and the second thickening agent comprises modified maize starch of preferred amount.

14. The product as claimed in claim 13, wherein the preferred amount of the first thickening agent is about 0.5%-1.2% of the weight of the food material.

15. The product as claimed in claim 13, wherein the preferred amount of the second thickening agent is about 5%-9% of the weight of the food material.

16. The product as claimed in claim 12 further comprising yeast extract.

17. The product as claimed in claim 12, wherein the product is in the form of a platelet with specific shape defined by a food container in which the product is contained and sealed.
